(19) United States
(12) Patent Application Publication
(10) Pub. No.: US 2026/0205777 A1
(43) Pub. Date: Jul. 16, 2026

(54) GENERATIVE AI USE AT TELECOMMUNICATIONS NETWORK ACCESS POINTS

(71) Applicant: T-Mobile USA, Inc., Bellevue, WA (US)

(72) Inventor: Dharmendra Adsule, Bellevue, WA (US)

(21) Appl. No.: 19/019,217

(22) Filed: Jan. 13, 2025

(51) Int. Cl. H04W 4/23; G06Q 30/0251; H04W 24/02; H04W 64/00

(52) U.S. Cl. CPC H04W 4/23; G06Q 30/0269; H04W 24/02; H04W 64/00

(57) ABSTRACT

Described herein is an access point of a telecommunications network configured to utilize a generative artificial intelligence (AI) component. The access point receives media item(s) for serving to user equipment(s) (UE(s)) connected to the access point and determines information about the UE(s) or about users of the UE(s). Based on the media item(s) and the information, the access point utilizes the generative AI component to select a media item from the media item(s) for serving to a UE of the UE(s) or customize a media item of the media item(s) for a UE of the UE(s) based on the determined information about the UE or the user of the UE. The access point then serves at least one of the media item(s) to at least one UE of the UE(s).

### BACKGROUND

With the increase in information known about network-connected users, there are more opportunities to provide customized or tailored content to those users than ever before. We might know a user's age, interests, current location, etc. We may even make reasonable assumptions about planned activities of the user. Knowing all this information, we still present users largely the same content—e.g., all users selected to receive an advertisement receive the same advertisement. To take advantage of what is known about a user, customizations must be generated in advance—likely for groups of users—or in closer to real-time by developers or content professionals.

Generative artificial intelligence (AI) can perform much of this same customization in closer to real-time and in a more user-specific manner. Often the information needed for such real-time or near-real-time customization or media selection is lacking, however. Without this information, generative AI may save time and costs but not greatly increase the specificity of the media.

### BRIEF DESCRIPTION OF THE DRAWINGS

The detailed description is set forth with reference to the accompanying figures. In the figures, the left-most digit(s) of a reference number identifies the figure in which the reference number first appears. The same reference numbers in different figures indicate similar or identical items.

FIG. 1 is an overview diagram showing media items and information about user equipments (UEs) and/or their users being input to a generative artificial intelligence (AI) component at an access point to enable the generative AI component to select or modify the media items for serving to the UEs.

FIG. 2 is a network architecture diagram of an access point of a telecommunications network, a UE, other nodes of the telecommunications network, and sources of media items, information, and large language models, these devices and components interacting to enable a generative AI component at the access point to modify or select a media item for the UE based on information about the UE or the user of the UE.

FIG. 3 is a flow diagram of an illustrative process for an access point of a telecommunications network to utilize a generative AI component to select a media item for a UE connected to the access point or to modify the media item based on information about the UE or the user of the UE.

FIG. 4 is a schematic diagram of a computing device capable of implementing functionality of at least one of the systems described herein.

### DETAILED DESCRIPTION

This disclosure is directed in part to an access point of a telecommunications network configured to utilize a generative artificial intelligence (AI) component. The access point receives media item(s) for serving to user equipment(s) (UE(s)) connected to the access point and determines information about the UE(s) or about users of the UE(s). Based on the media item(s) and the information, the access point utilizes the generative AI component to select a media item from the media item(s) for serving to a UE of the UE(s) or customize a media item of the media item(s) for a UE of the UE(s). The access point then serves at least one of the media item(s) to at least one UE of the UE(s).

Information about a UE or user may be subject to privacy constraints and would be used in accordance with any applicable laws. Further, use of a user's private information could be on an opt-in basis, with the information only used upon obtaining the user's permission. Additionally or alternatively, information could be anonymized (e.g., aggregated with a sufficient number of other users) and used on the anonymized basis.

In various implementations, information about a UE or a user of a UE may be real-time or near-real-time information, such as a current location of the UE, a time-of-day at the current location, or an event at the current location and time-of-day. Other information may include information known to the access point or to another device of the telecommunications network about of the UE or the user of the UE. Further, the information may include a name of the user, an age of the user, a sex of the use, an orientation of the user, a user browsing history, a user search history, previous purchases by the user and/or using the UE, or interests of the user. The access point may store some or all of the UE or user information, may retrieve some or all of the UE/user information from the UE, may retrieve some or all of the UE/user information from another node of the telecommunications network, and/or may retrieve some or all of the UE/user information from a source of information external to the telecommunications network. The access point may retrieve the UE/user information when the UE connects to the access point or at a later time—e.g., when there is a media item to serve to the UE.

The media items served to the UE may be advertisements or other content types which a content provider, an operator or the telecommunications network, or a content recipient wishes to have customized or selected more precisely. These media items may be videos, images, audio files, text files, etc. The access point may receive the media items from another node of the telecommunications network which may in turn receive the media items from one or more media providers. The media items may be part of a transmission specifying UE(s) or may leave UE selection to the discretion of the access point.

The access point utilizes the generative AI component located at the access point to select or customize media items based on the UE/user information. The generative AI component may have a large language model (LLM) receive from a central LMM of the telecommunications network that is used to provision and update LLMs at the access points of the telecommunications network. The central LLM may in turn reflect external LLM sources or may be developed using only data that is internal to the telecommunications network. The access point may further update the LLM it receives—e.g., based on UE/user information, network information (e.g., metrics of performance such as signal strength, latency, etc.). The generative AI component may interface with other components of the access point through, e.g., application programing interfaces (APIs) to receive a media item and UE/user information. Based on its LLM, on the UE/user information, and on the media item, the generative AI component may produce a customized media item, select a media item for UE(s), or both.

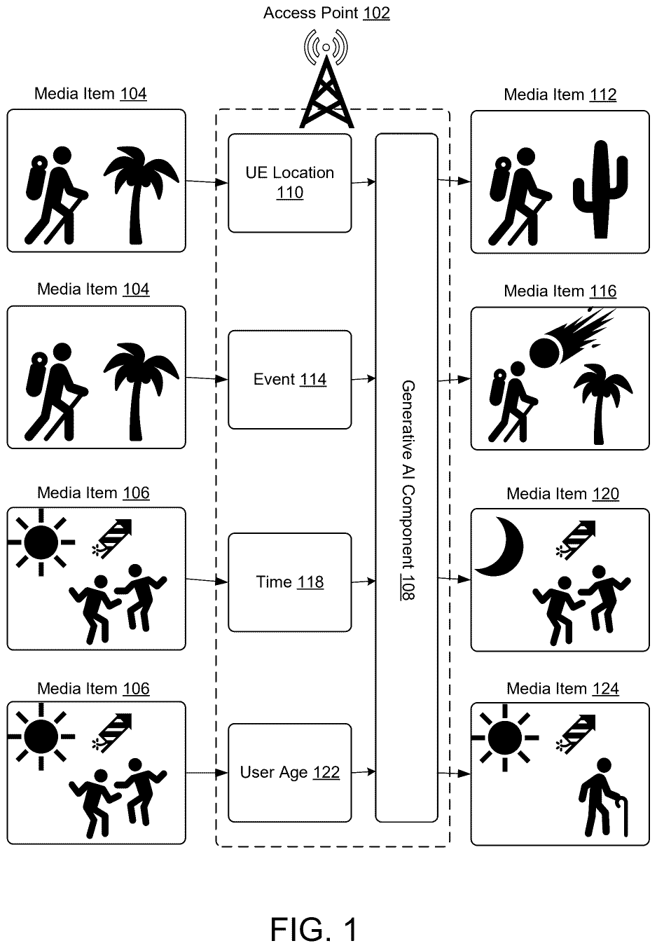

FIG. 1 is an overview diagram showing media items and information about user equipments (UEs) and/or their users being input to a generative artificial intelligence (AI) component at an access point to enable the generative AI component to select or modify the media items for serving to the UEs. As illustrated, an access point 102 may receive media items 104 and 106. Using its generative AI component 108 and UE/user information, the access point 102 customizes the media items 104 and 106. When the UE/user information is a UE location 110, the generative AI component 108 may customize the media item 104 based on the user location 110 to produce the customized media item 112. When the UE/user information is an event 114 at a UE location, the generative AI component 108 may customize the media item 104 based on the event 114 to produce the customized media item 116. When the UE/user information is a time 118 at a UE location, the generative AI component 108 may customize the media item 106 based on the time 118 to produce the customized media item 120. When the UE/user information is a user age 122, the generative AI component 108 may customize the media item 106 based on the user age 122 to produce the customized media item 124.

As an initial matter, it is noted that FIG. 1 illustrates one specific example of using generative AI component 108 with UE/user information to customize media items 104 and 106. The same UE/user information could be used to modify a single media item in multiple different ways; it could also be used with additional media items. Additionally, more or fewer items/types of UE/user information could be used to customize more or fewer media items. Besides the customizations shown in FIG. 1, the UE/user information may be used by the generative AI component 108 to select media items for UEs/users. In some examples, the generative AI component 108 may cluster UEs/users and select media items for those clusters. Such selections are described in detail herein but are not shown in FIG. 1.

Devices and components shown in FIG. 1, including the access point 102 and generative AI component 108, are described in further detail herein.

In the example illustrated in FIG. 1, the access point 102 has received two media items—104 and 106. Media item 104 is an image of a hiker with a palm tree background. Media item 106 is an image of two people dancing during the daytime while fireworks go off. The access point 102 provides these to its generative AI component 108 and retrieves UE/user information. Such UE/user information can be for all UEs connected to the access point 102 or a subset of these. The various items of information shown—UE location 110, event 114, time 118, and user age 122 may all pertain to the same user and UE, may each pertain to a different UE/user, multiple ones of these may apply to a single UE/user while other(s) apply to different UE(s)/user(s). The UE location 110 may be a desert environment, and the generative AI component 108 may modify the background of the media item 104, replacing the palm tree with a cactus to produce media item 112. The event 114 may be an emergency, such as a meteor shower, and the generative AI component 108 may modify the background of media item 104, adding a depiction of falling meteors to produce media item 116. The time 118 may be sometime in the evening, and the generative AI component 108 may modify the background of media item 106 to replace the sun with the moon to produce media item 120. The user age 122 may indicate that the user is elderly, and the generative AI component 108 may modify the people shown in the media item 106 to replace those people with an elderly person to produce media item 124. The media items 112, 116, 120, and 124 may then be served to the UE(s) that correspond to the information 110, 114, 118, and 122 used to produce those media items 112, 116, 120, and 124.

In another example, a user may be away from home at a mealtime and may have a habit of eating out. Information indicating these things (UE location, time-of-day, user purchase history, etc.) may cause a generative AI component at an access point connected to the user's UE to select restaurant reviews and/or advertisements to serve the user. Further, the information about the user may indicate that she is driving, so the generative AI component may modify the review/advertisement to add directions to the restaurant that either play audibly from the UE or are provided to a GPS system on the UE or car to direct the user.

In a further example, a user may be browsing content online and is served an advertisement that shows the user's neighborhood covered in snow due to a projected weather event and prompts the user to order groceries or essential items from his nearest store. The imagery in the advertisement can be based on street view pictures of the user's neighborhood sourced from available services like Google Street view or others.

In an additional example, a user may have shown interest in a product that is endorsed by the user's favorite celebrity, sports person, politician, influencer or other personality. The generative AI component then would customize a media item for the product by having images, audio, or text associated with the celebrity added to the media item.

In another example, users at a sports arena can be served customized advertisements based on their affiliation to their favorite team and the way the game is progressing. Fans of the winning team could be served AI-customized versions of the advertisement featuring players who have impacted the game.

In a further example, a user who is browsing content may be served an advertisement showing opportunities to invest in their preferred company's stocks based on their past activity and the real-time update from the Stock exchanges.

In an additional example, a user may be caught in highway slow-down. The user can be served advertisements from ride-share apps encouraging them to take up ride-share rather than being stuck. The generative AI component can show them exactly how bad the slowdown is and feature a creative that shows how they could have spent the time relaxed while someone else drove them to their destination.

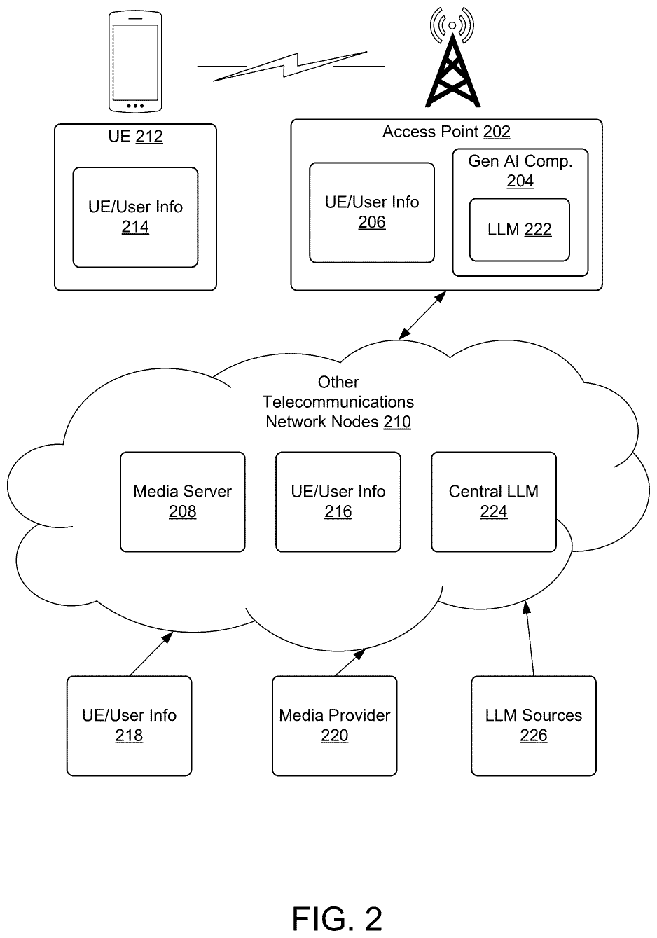

FIG. 2 is a network architecture diagram of an access point of a telecommunications network, a UE, other nodes of the telecommunications network, and sources of media items, information, and large language models, these devices and components interacting to enable a generative AI component at the access point to modify or select a media item for the UE based on information about the UE or the user of the UE. As illustrated, the access point 202 of a telecommunications network may include a generative AI component 204 and UE/user information 206. The access point 202 may receive media items from a media server 208, which may be among other nodes 210 of the telecommunications network. The access point 202 may select and/or customize media items and serve those media items a UE 212. The UE 212 may also provide UE/user information 214. A node 210 of the telecommunications network may also/instead provide UE/user information 216, and a source external to the telecommunications network may provide UE/user information 218. In some examples, the media items served by the media server 208 may be received from a media provider 220 that is external to the telecommunications network. Additionally, the generative AI component 204 may include a LLM 222 that may be provisioned/updated from a central LLM 224 of the telecommunications network, which may in turn be built/modified from LLM sources 226 external to the telecommunications network.

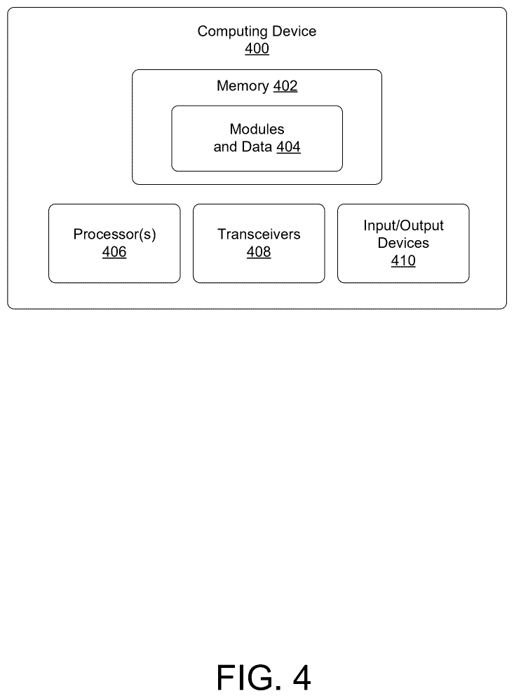

In various implementations, the access point 202 may be an example of access point 102. The access point 202 may provide wireless access to UEs, including UE 212, in an area defined by a cell associated with the access point 202. The access point 202 may be part of a base station, and may utilize licensed spectrum, unlicensed spectrum, or both. The size of its associated cell may be large (e.g., a macrocell) or smaller (e.g., a microcell, femtocell, etc.). Further, the access point may be associated with any radio access technology (e.g., Long Term Evolution (LTE), New Radio (NR), etc.). The access point 202 may include transceivers, such as radio antennae for sending and receiving wireless signals, as well as other physical equipment. An example computing device capable of implementing the access point is illustrated in FIG. 4 and is described below in detail.

The UE 212 may be any sort of wireless communication device, such as a cellular phone, a tablet computer, an Internet-of-Things (IoT) device (e.g., a watch, glasses, goggles, etc.), a gaming device, etc. The user of the UE 212 may subscribe for services of an operator of the telecommunications network that includes the access point 202 and other telecommunications network nodes 210 and may use the UE 212 to access those services. From time to time, the UE 212 may receive media items from the telecommunications network, either in response to requests from the UE 212 or pushed to the UE 212. The media items are then rendered on the UE 212 in whatever manner is best suited by the type(s) of the media items and the capabilities of the UE 212.

The other nodes illustrated in FIG. 2—the media server 208, nodes 210 storing/generating the UE/user info 216 and central LLM 224, and nodes external to the telecommunications network, such as the media provider 220 and the nodes storing/generating the UE/user information 218 and the LLM sources 226—may each be any sort of computing device or computing devices. In some implementations, these nodes may include virtual devices implemented by one or more computing devices. In further implementations, multiple ones of the nodes may be implemented in a single physical computing device or virtual device.

In various implementations, the devices and components of FIG. 2 are connected at least by or to a telecommunications network, which may include any one or more generations of technology, such as sixth generation (6G) technology, fifth generation (5G) technology, fourth generation (4G) technology, third generation (3G) technology, etc. The telecommunications network may include at least access network(s) and a core network. In some examples, the access point 202 may be part of an access network and the nodes including the media server 208, UE/user information 216, and central LLM 224 may be part of the core network. Access points, such as access point 202, may be connected to nodes of the core network by a backhaul, which may comprise wired components (e.g., Ethernet lines), wireless components, or both. The various access points may provide connectivity by wirelessly transmitting and receiving on wireless spectrum, enabling UEs, such as UE 212, to connect to the telecommunications network.

In some implementations, the nodes external to the telecommunications network may connect to gateway(s) of the telecommunications network through one or more external networks, such as the Internet, public wide area networks (WANs) private WANs, or a combination of two or more of such networks.

In various implementations, the generative AI component 204 may be an instance of any generative AI and may draw as sources for its LLM 222 only sources internal to the telecommunications network and/or network(s) affiliated with the operator of the network or both such sources and external sources. The generative AI component 204 may interact programmatically with other components of the access point 202 through, e.g., APIs.

As previously noted herein, the LLM 222 may be provisioned and/or updated from the central LLM 224. It may also be updated based on, e.g., user interaction data reflecting user interactions with media items, as well as other data available to the access point 202 (e.g., performance metrics). The central LLM 224 may be updated based on LLMs of access points, including LLM 222, and based on other information available to nodes 210 of the telecommunications network. In building the central LLM 224, the operator of the telecommunications network may make use of LLM sources 226, which may provide a starting point or sources of information for updating the central LLM 224.

In various implementations, the media provider 220 may comprise a media server, a media repository, etc. of the same entity as the operator of the telecommunications network or a different entity. The media provider 220 may provide advertisements, commercial videos, images, songs, podcasts, etc. When providing through/to the media server 208, the media provider 220 may transmit through one or more nodes 210, such as a gateway node. In some implementations, the media provider 220 may maintain rights in the media items provided and may assent to the processing and customization by generative AI components, such as generative AI component 204. The media server 208 may then simply relay the media items to the access points, including access point 202, or may provide them selectively—e.g., in response to a UE 212 request for the media item. In one example, the media items may be advertisements associated with a web page or application and may be provided to any access points connected to UEs that are accessing the web page/application. In another example, the media item may be broadcast to all UEs, or all UEs connected to a given access point or subset of access points. When the access point 202 receives media items, it may receive them as a separate transmission and identify them as media items by a transmission header. Alternatively, the media items may be transmitted with other data types and with an indication that the transmission includes the media items.

In various implementations, the UE/user information 206 may be information tracked by the access point 202 or received in reports or transmissions. Other UE/user information 214, 216, and 218 may be retrieved by the access point 202 or another component. If retrieved by another component, that component provides the UE/user information 214, 216, and 218 to the access point 202, either with the media items or at a different time or times than the media items. Examples of the UE/user information 206, 214, 216, and/or 218 may include real-time or near-real-time information, such as a current location of the UE, a time-of-day at the current location, or an event at the current location and time-of-day. Such UE/user information 206, 214, 216, and/or 218 may also or instead include information known to the access point 202 or to another device of the telecommunications network about of the UE 212 or the user of the UE 212. Further, the UE/user information 206, 214, 216, and/or 218 may include a name of the user, an age of the user, a sex of the use, an orientation of the user, a user browsing history, a user search history, previous purchases by the user and/or using the UE 212, or interests of the user. The access point 202 may store some or all of the UE or user information (e.g., UE/user information 206), may retrieve some or all of the UE/user information 214 from the UE 212, may retrieve some or all of the UE/user information 216 from another node 210 of the telecommunications network, and/or may retrieve some or all of the UE/user information 218 from a source of information external to the telecommunications network. The access point 202 may retrieve the UE/user information 206, 214, 216, and/or 218 when the UE 212 connects to the access point 202 or at a later time—e.g., when there is a media item to serve to the UE 212. As also noted herein, use of UE/user information will be in accordance with laws and may take measures to protect user privacy such as requiring the user to opt-in for the UE/user information to be used.

Based on the media items received and the UE/user information 206, 214, 216, and/or 218 (hereinafter referred to as “UE/user information 206”), the access point 202 utilizes the generative AI component 204 to select a media item, customize a media item, or perform both such operations. In some examples, multiple alternative media items may be received for a UE 212. The generative AI component 204 may consider these alternative media items and the UE/user information 206 and select one of the alternative media items to serve to the UE 212. For example, one media item may be an advertisement for a restaurant and another may be an advertisement for a streaming movie. The generative AI component 204 may select one or the other based on, e.g., a time-of-day and/or a UE location. In another example, one media item may have a large size, and the alternative may have a smaller size. The generative AI component 204 may select between the larger and smaller media items based on, e.g., network conditions.

In some implementations, in addition to or instead of selecting a media item, the generative AI component 204 may be used by the access point 202 to customize a media item. Customizing may include modifying a background of a media item, adding audio or text-based information to a media item, or adding or removing features of a media item. Customizing may also include creating a customized version of a media item for each UE 212 connected to the access point 202, such that each UE 212 is served a different customized version of the media item. Further examples of customizations are discussed herein.

As noted, a media item may both be selected for a UE 212 and then customized for the UE 212 using the generative AI component 204.

Once a media item has been selected and/or customized using the generative AI component 204, the access point 202 provides the media item to the UE 212. The UE 212 may then render the media item in accordance with a content type of the media item and capabilities of the UE 212.

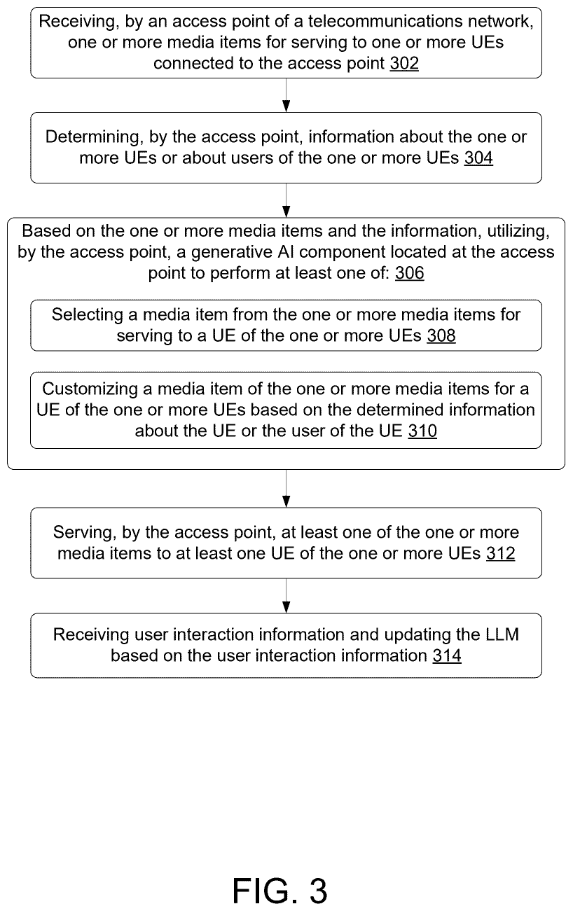

FIG. 3 illustrates an example process. This process is illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 3 is a flow diagram of an illustrative process for an access point of a telecommunications network to utilize a generative AI component to select a media item for a UE connected to the access point or to modify the media item based on information about the UE or the user of the UE. As illustrated at 302, an access point of a telecommunications network may receive one or more media items for serving to one or more UEs connected to the access point. The one or more media items may be provided to the access point separately from other downlink in a dedicated transmission to the access point or may be provided with other downlink but each have a descriptor that is readable by the access point.

At 304, the access point may determine information about the one or more UEs or about users of the one or more UEs. In some implementations, the information may include at least one of a current user location, time-sensitive information about a UE of the one or more UEs or a user of a UE of the one or more UEs, or information known to the access point or to another device of the telecommunications network about of a UE of the one or more UEs or a user of a UE of the one or more UEs. In further implementations, the information may include at least one of a name, an age, a sex, an orientation, a browsing history, a search history, previous purchases, or interests.

At 306, based on the one or more media items and the information, the access point may utilize a generative AI component located at the access point to perform at least one of selecting, at 308, a media item from the one or more media items for serving to a UE of the one or more UEs or customizing, at 310, a media item of the one or more media items for a UE of the one or more UEs based on the determined information about the UE or the user of the UE.

In some examples, selecting at 308 may comprise clustering UEs of the one or more UEs and matching each cluster with a media item of the one or more media items.

The customizing, at 310, may include modifying a background of a media item of the one or more media items, adding audio or text-based information to a media item of the one or more media items, or adding or removing features of a media item of the one or more media items. Alternatively or additionally, the customizing may comprise updating the one or more media items with real-time information. Further, the customizing may comprise creating a customized version of a media item of the one or more media items for each UE of the one or more UEs, such that each UE of the one or more UEs is served a different customized version of the media item.

In one example, the utilizing may comprise utilizing the generative AI component to perform selecting a restaurant advertisement as the media item and customizing the restaurant advertisement by adding audio or text-based directions to the restaurant advertisement from a current location of a UE that is to receive the restaurant advertisement.

In various implementations, the generative AI component may include a LLM trained with information specific to a location or with information specific to users having the location as a home location or an office location. Such an LLM may be updatable by a central repository LLM of another node of the telecommunications network.

At 312, the access point may serve at least one of the one or more media items to at least one UE of the one or more UEs.

At 314, the access point may receive user interaction information and may update the LLM based on the user interaction information.

FIG. 4 is a schematic diagram of a computing device capable of implementing functionality of at least one of the systems described herein. As shown, the computing device 400 includes a memory 402 storing modules and data 404, processor(s) 406, transceivers 408, and input/output devices 410.

In various examples, the memory 402 can include system memory, which may be volatile (such as RAM), non-volatile (such as ROM, flash memory, etc.) or some combination of the two. The memory 402 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 402 can include one or more software or firmware elements, such as computer-readable instructions that are executable by the one or more processors 406. For example, the memory 402 can store computer-executable instructions associated with modules and data 404. The modules and data 404 can include a platform, operating system, and applications, and data utilized by the platform, operating system, and applications. Further, the modules and data 404 can implement any of the functionality for the devices and components described and illustrated herein.

In various examples, the processor(s) 406 can be a central processing unit (CPU), a graphics processing unit (GPU), or both CPU and GPU, or any other type of processing unit. Each of the one or more processor(s) 406 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 406 may also be responsible for executing all computer applications stored in the memory 402, which can be associated with types of volatile (RAM) and/or nonvolatile (ROM) memory.

The transceivers 408 can include modems, interfaces, antennas, Ethernet ports, cable interface components, and/or other components that perform or assist in exchanging wireless communications, wired communications, or both.

While the computing device need not include input/output devices 410, in some implementations it may include one, some, or all of these. For example, the input/output devices 410 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 410 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 410 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

Also, while the descriptions provided herein may be in the context of certain radio access technologies, networks, and network topologies, such as Fifth Generation (5G)/new radio (NR) mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and NTN communications. Thus, the scope of the disclosure is not limited to the examples described herein.

What is claimed is:

1. A method comprising:
receiving, by an access point of a telecommunications network, one or more media items for serving to one or more user equipments (UEs) connected to the access point;
determining, by the access point, information about the one or more UEs or about users of the one or more UEs;
based on the one or more media items and the information, utilizing, by the access point, a generative artificial intelligence (AI) component located at the access point to perform at least one of:
selecting a media item from the one or more media items for serving to a UE of the one or more UEs, or
customizing a media item of the one or more media items for a UE of the one or more UEs based on the determined information about the UE or the user of the UE; and
serving, by the access point, at least one of the one or more media items to at least one UE of the one or more UEs.

2. The method of claim 1, wherein the information includes at least one of a current user location, time-sensitive information about a UE of the one or more UEs or a user of a UE of the one or more UEs, or information known to the access point or to another device of the telecommunications network about of a UE of the one or more UEs or a user of a UE of the one or more UEs.

3. The method of claim 1, wherein the information includes at least one of a name, an age, a sex, an orientation, a browsing history, a search history, previous purchases, or interests.

4. The method of claim 1, wherein the customizing includes modifying a background of a media item of the one or more media items, adding audio or text-based information to a media item of the one or more media items, or adding or removing features of a media item of the one or more media items.

5. The method of claim 4, wherein the utilizing comprises utilizing the generative AI component to perform selecting a restaurant advertisement as the media item and customizing the restaurant advertisement by adding audio or text-based directions to the restaurant advertisement from a current location of a UE that is to receive the restaurant advertisement.

6. The method of claim 1, wherein the generative AI component includes a large language model (LLM) trained with information specific to a location or with information specific to users having the location as a home location or an office location.

7. The method of claim 6, wherein the LLM is updatable by a central repository LLM of another node of the telecommunications network.

8. The method of claim 6, further comprising receiving user interaction information and updating the LLM based on the user interaction information.

9. The method of claim 1, wherein the selecting comprises clustering UEs of the one or more UEs and matching each cluster with a media item of the one or more media items.

10. The method of claim 1, wherein the customizing comprises updating the one or more media items with real-time information.

11. The method of claim 1, wherein the customizing comprises creating a customized version of a media item of the one or more media items for each UE of the one or more UEs, such that each UE of the one or more UEs is served a different customized version of the media item.

12. The method of claim 1, wherein the one or more media items are provided separately from other downlink in a dedicated transmission to the access point or are provided with other downlink but each have a descriptor that is readable by the access point.

13. An access point of a telecommunications network, the access point comprising:
one or more processors; and
programming instructions that, when executed by the one or more processors, cause the access point to perform operations including:
receiving one or more media items for serving to one or more user equipments (UEs) connected to the access point;
determining information about the one or more UEs or about users of the one or more UEs;
based on the one or more media items and the information, utilizing a generative artificial intelligence (AI) component located at the access point to perform at least one of:
selecting a media item from the one or more media items for serving to a UE of the one or more UEs, or
customizing a media item of the one or more media items for a UE of the one or more UEs based on the determined information about the UE or the user of the UE; and
serving at least one of the one or more media items to at least one UE of the one or more UEs.

14. The access point of claim 13, wherein the information includes at least one of a current user location, time-sensitive information about a UE of the one or more UEs or a user of a UE of the one or more UEs, information known to the access point or to another device of the telecommunications network about of a UE of the one or more UEs or a user of a UE of the one or more UEs, a name, an age, a sex, an orientation, a browsing history, a search history, previous purchases, or interests.

15. The access point of claim 13, wherein the generative AI component includes a large language model (LLM) trained with information specific to a location or with information specific to users having the location as a home location or an office location.

16. The access point of claim 13, wherein the customizing comprises updating the one or more media items with real-time information, modifying a background of a media item of the one or more media items, adding audio or text-based information to a media item of the one or more media items, or adding or removing features of a media item of the one or more media items.

17. The access point of claim 13, wherein the customizing comprises creating a customized version of a media item of the one or more media items for each UE of the one or more UEs, such that each UE of the one or more UEs is served a different customized version of the media item.

18. A non-transitory computer storage medium having stored thereon programming instructions that, when executed by one or more processors of an access point of a telecommunications network, cause the access point to perform operations comprising:
receiving one or more media items for serving to one or more user equipments (UEs) connected to the access point;
determining information about the one or more UEs or about users of the one or more UEs;
based on the one or more media items and the information, utilizing a generative artificial intelligence (AI) component located at the access point to perform at least one of:
selecting a media item from the one or more media items for serving to a UE of the one or more UEs, or
customizing a media item of the one or more media items for a UE of the one or more UEs based on the determined information about the UE or the user of the UE; and
serving at least one of the one or more media items to at least one UE of the one or more UEs.

19. The non-transitory computer storage medium of claim 18, wherein the information includes at least one of a current user location, time-sensitive information about a UE of the one or more UEs or a user of a UE of the one or more UEs, information known to the access point or to another device of the telecommunications network about of a UE of the one or more UEs or a user of a UE of the one or more UEs, a name, an age, a sex, an orientation, a browsing history, a search history, previous purchases, or interests.

20. The non-transitory computer storage medium of claim 18, wherein the customizing comprises creating a customized version of a media item of the one or more media items for each UE of the one or more UEs, such that each UE of the one or more UEs is served a different customized version of the media item.
